(19) United States
(12) Patent Application Publication
(10) Pub. No.: US 2023/0307646 A1
(43) Pub. Date: Sep. 28, 2023

(54) LITHIUM SECONDARY BATTERY

(71) Applicant: HONDA MOTOR CO., LTD., Tokyo (JP)

(72) Inventor: Kazuki SAIMEN, Saitama (JP)

(21) Appl. No.: 18/170,562

(22) Filed: Feb. 17, 2023

(30) Foreign Application Priority Data
Mar. 25, 2022 (JP) 2022-049887

(51) Int. Cl. H01M 4/62; H01M 10/0525; H01M 4/13; H01M 4/36; H01M 4/38; H01M 4/40

(52) U.S. Cl. CPC H01M 4/62; H01M 10/0525; H01M 4/13; H01M 4/366; H01M 4/382; H01M 4/405; H01M 2004/028

(57) ABSTRACT

To provide a lithium secondary battery including a positive electrode, a negative electrode and an electrolytic solution, wherein the positive electrode includes an interlayer and a positive electrode mixture layer sequentially stacked on a positive electrode current collector, and the interlayer contains a pre-doping agent, a conductive aid and a binder.

This application is based on and claims the benefit of priority from Japanese Patent Application 2022-049887, filed on 25 Mar. 2022, the content of which is incorporated herein by reference.

### BACKGROUND OF THE INVENTION

### Field of the Invention

The present invention relates to a lithium secondary battery.

### Related Art

In recent years, research and development have been carried out on secondary batteries which contribute to energy efficiency in order to ensure that many people have access to affordable, reliable, sustainable and advanced energy. For example, a lithium metal negative electrode has attracted attention for its voltage increasing when used as a negative electrode of a lithium ion secondary battery because of its higher capacity density compared to a graphite negative electrode of a lithium ion secondary battery.

However, during initial charging/discharging of the lithium secondary battery, an electrolyte undergoes decomposition at an interface between the lithium metal negative electrode and the electrolytic solution to form an SEI coating. At this time, lithium ions are consumed to generate an irreversible capacity, leading to a reduction in capacity of the lithium secondary battery.

Therefore, it is known to add a pre-doping agent to a positive electrode mixture layer to compensate for irreversible capacitance (see, for example, Patent Document 1).

Patent Document 1: Japanese Unexamined Patent Application, Publication No. H9-147863

### SUMMARY OF THE INVENTION

However, the pre-doping agent cannot contribute to the capacity of the lithium secondary battery during charging/discharging cycle, leading to non-uniform storing and releasing of lithium ions in the positive electrode mixture layer. As a result, the growth of lithium metal in the negative electrode becomes non-uniform, leading to deterioration of the durability of the lithium secondary battery.

In is an object of the present invention to provide a lithium secondary battery having excellent durability.

In accordance with one aspect of the present invention, there is provided a lithium secondary battery including a positive electrode, a negative electrode and an electrolytic solution, in which the positive electrode includes an interlayer and a positive electrode mixture layer sequentially stacked on a positive electrode current collector, and the interlayer contains a pre-doping agent, a conductive aid and a binder.

In the negative electrode, a lithium metal layer, a lithium alloy layer or a negative electrode mixture layer may be formed on a negative electrode current collector.

The interlayer may have a thickness of 1 μm or more and 20 μm or less.

A ratio of the mass of the conductive aid with respect to the total mass of the pre-doping agent and the conductive aid in the interlayer may be 0.01 or more and 0.10 or less.

The pre-doping agent may have a median size (D₅₀) of 10 μm or less.

The pre-doping agent may have an initial irreversible capacity of 50% or more and an initial charging capacity of 300 mAh/g or more.

The pre-doping agent may be a metal oxide having an inverse-fluorite structure represented by formula:

LiₐMe_{b}X_{(1-b)}O₄
wherein a is 5 or more and 6 or less, b is 0.8 or more and 1 or less, Me is one or more elements selected from the group consisting of Co, Mn and Fe, and X is a metal element other than Co, Mn, Fe and Ni, and
a surface of the metal oxide may be coated with the conductive aid.

According to the present invention, it is possible to provide a lithium secondary battery having excellent durability.

### DETAILED DESCRIPTION OF THE INVENTION

Hereinafter, embodiments of the present invention will be described.

The lithium secondary battery of the present embodiment includes a positive electrode, a negative electrode and an electrolytic solution. Here, regarding the positive electrode, an interlayer and a positive electrode mixture layer are sequentially stacked on a positive electrode current collector. The interlayer contains a pre-doping agent, a conductive aid and a binder.

In the lithium secondary battery of the present embodiment, since the pre-doping agent is contained in the interlayer, storage and release of lithium ions in the positive electrode mixture layer are made uniform during charging/discharging cycle. As a result, since the growth of lithium metal in the negative electrode is made uniform, the lithium secondary battery of the present embodiment is excellent in durability.

Examples of the lithium secondary battery of the present embodiment include, but are not particularly limited to, a lithium ion secondary battery, a lithium metal secondary battery and the like.

The lithium secondary battery of the present embodiment can be produced, for example, by sandwiching a separator between a positive electrode and a negative electrode, and then injecting an electrolytic solution into the separator.

### [Positive Electrode]

Regarding the positive electrode, as mentioned above, the interlayer and the positive electrode mixture layer are sequentially stacked on the positive electrode current collector.

### (Interlayer)

The pre-doping agent is not particularly limited as long as lithium ions can be released during initial charging/discharging of the lithium secondary battery and is, for example, a metal oxide having an inverse-fluorite structure represented by formula:

LiₐMe_{b}X_{(1-b)}O₄
wherein a is 5 or more and 6 or less, b is 0.8 or more and 1 or less, Me is one or more elements selected from the group consisting of Co, Mn and Fe, and X is a metal element other than Co, Mn, Fe and Ni.

Specific examples of the pre-doping agent include Li₆MnO₄, Li₅FeO₄, Li₆CoO₄ and the like.

The median size (D₅₀) of the pre-doping agent is preferably 10 μm or less, and more preferably 4 μm or less. If the median size (D₅₀) of the pre-doping agent is 10 μm or less, the charging capacity density of the lithium secondary battery of the present embodiment is improved. It should be noted that the median size (D₅₀) of the pre-doping agent is not particularly limited and is preferably, for example, 0.5 μm or more.

The initial irreversible capacity of the pre-doping agent is preferably 50% or more, and more preferably 90% or more. If the initial irreversible capacity of the pre-doping agent is 50% or more, excessive increase in thickness of the positive electrode is suppressed.

The initial charging capacity of the pre-doping agent is preferably 300 mAh/g or more, and more preferably 500 mAh/g or more. If the initial charging capacity of the pre-doping agent is 300 mAh/g or more, excessive increase in thickness of the positive electrode is suppressed.

Examples of the conductive aid include, but are not particularly limited to, acetylene black, furnace black and the like.

A ratio of the mass of the conductive aid to the total mass of the pre-doping agent and the conductive aid in the interlayer is preferably 0.01 or more and 0.10 or less, and mote preferably 0.025 or more and 0.05 or less. If the ratio of the mass of the conductive aid to the total mass of the pre-doping agent and the conductive aid in the interlayer is 0.01 or more, the initial resistance of the lithium secondary battery of the present embodiment decreases, and if the ratio is 0.10 or less, the durability of the lithium secondary battery of the present embodiment is improved.

It is preferred that a surface of the pre-doping agent is coated with a conductive aid. Thereby, the initial resistance the lithium secondary battery of the present embodiment decreases.

Examples of the binder include, but are not particularly limited to, polyvinylidene fluoride, polytetrafluoroethylene and the like.

The thickness of the interlayer is preferably 1 μm or more and 20 μm or less, and more preferably 5 μm or more and 15 μm or less. If the thickness of the interlayer is 1 μm or more, the durability of the lithium secondary battery of the present embodiment is improved, and if the thickness is 20 μm or less, an increase in resistance of the lithium secondary battery of the present embodiment is suppressed.

### (Positive Electrode Mixture Layer)

The positive electrode mixture layer may contain a positive electrode active material, and may further contain a conductive aid, a binder and the like as necessary.

The positive electrode active material is not particularly limited as long as it is capable of storing and releasing lithium ions, and examples thereof include lithium composite oxides such as LiCoO₂, Li(Ni_{5/10}Co_{2/10}Mn_{3/10})O₂, Li(Ni_{6/10}Co_{2/10}Mn_{2/10})O₂, Li(N_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂ and LiFePO₄.

Examples of the conductive aid include, but are not particularly limited to, acetylene black, furnace black and the like.

Examples of the binder include, but are not particularly limited to, polyvinylidene fluoride, polytetrafluoroethylene and the like.

### (Positive Electrode Current Collector)

Examples of the positive electrode current collector include, but are not particularly limited to, a metal foil and the like. Examples of metal constituting the metal foil include aluminum and the like.

The positive electrode current collector may have through holes. In this case, since the interlayer is partially filled into through holes of the positive electrode current collector, the positive electrode can be made thinner. Examples of the positive electrode current collector having through holes include metal foam, metal mesh, expanded metal, perforated metal, metal nonwoven fabric and the like.

### [Negative Electrode]

Regarding the negative electrode, a lithium metal layer, a lithium alloy layer or a negative electrode mixture layer may be formed on a negative electrode current collector.

### (Lithium Metal Layer or Lithium Alloy Layer)

Examples of the material constituting the lithium alloy include, but are not particularly limited to, tin, bismuth, antimony, zinc, copper and the like, and two or more thereof may be used in combination.

Note that when the lithium secondary battery of the present embodiment is an anode-free lithium ion secondary battery, the negative electrode in an initial state is composed only of a negative electrode current collector.

### (Negative Electrode Mixture Layer)

The negative electrode mixture layer may contain a negative electrode active material, and may further contain a conductive aid, a binder and the like as necessary.

The negative electrode active material is not particularly limited as long as it is capable of storing and releasing lithium ions, and examples thereof include metal lithium, lithium alloy, metal oxide, metal sulfide, metal nitride, Si, SiO, carbon material and the like. Examples of the carbon material include artificial graphite, natural graphite, hard carbon, soft carbon and the like.

Examples of the conductive aid include, but are not particularly limited to, acetylene black, furnace black and the like.

Examples of the binder include, but are not particularly limited to, sodium carboxymethyl cellulose, styrene-butadiene rubber, sodium polyacrylate and the like.

(Negative Electrode Current Collector) Examples of the negative electrode current collector include, but are not particularly limited to, a copper foil and the like.

### [Electrolytic Solution]

The electrolytic solution contains an electrolyte dissolved in a solvent.

Examples of the electrolyte include, but are not particularly limited to, lithium bis(fluorosulfonyl)imide (LiFSI), lithium hexafluorophosphate, lithium hexafluoroborate, lithium bis(trifluoromethanesulfonyl)imide and the like, and two or more thereof may be used in combination.

Examples of the solvent include, but are not particularly limited to, ethylene carbonate, propylene carbonate, dimethyl ether (DME), fluoroethylene carbonate, dimethyl carbonate, hydrofluoroether, ethyl methyl carbonate, diethyl carbonate and the like, and two or more thereof may be used in combination.

While embodiments of the present invention have been described, the present invention is not limited to the above embodiments and the above embodiments may be appropriately varied within the spirit of the present invention.

### EXAMPLES

Examples of the present invention will be described below, but the present invention is not limited to the following Examples.

### [Synthesis 1 of Pre-Doping Agent]

Using an agate mortar, 5.583 g of Li₂O and 4.418 g of MnO were mixed, and then the mixture was calcined in an Ar atmosphere at 900° C. for 12 hours to obtain Li₆MnO₄.

### [Synthesis 2 of Pre-Doping Agent]

Using an agate mortar, 4.65 g of Li₂O and 4.97 g of Fe₂O₃ were mixed, and then the mixture was calcined in an Ar atmosphere at 800° C. for 12 hours to obtain LisFeO₄.

### [Post-Treatment of Pre-Doping Agent]

Using balls having a diameter of 1 mm and a ball mill device, a pre-doping agent was pulverized at 800 rpm for 1 hour. A predetermined amount (see Table 1) of acetylene black (AB) as a conductive aid was added, and then dispersed at 400 rpm for 30 minutes to obtain a pre-doping agent having a surface coated with AB.

Polystyrene was dissolved in butyl acetate, and then the pre-doping agent having a surface coated with AB was dispersed in the solution. Using a rotary evaporator, the solvent was removed to obtain a pre-doping agent having a surface coated with polystyrene. In an Ar atmosphere, the pre-doping agent was then calcined at 700° C. to obtain a pre-doping agent having an AB-supported surface.

### [Median Size (D₅₀) of Pre-Doping Agent]

Using a particle size analyzer by a laser diffraction scattering method (manufactured by Beckman Coulter), a pre-doping agent was dispersed in isopropyl alcohol, and then a median size (D₅₀) of a pre-doping agent was measured.

### [Initial Irreversible Capacity and Initial Charging Capacity of Pre-Doping Agent]

When the initial performance of a lithium metal secondary battery cell mentioned below is evaluated, a positive electrode was fabricated without adding a pre-doping agent, and then discharging/charging capacity per 1 g of the positive electrode was measured. Thereafter, the initial irreversible capacity and the initial charging capacity of each pre-doping agent were calculated from an increase in discharging/charging capacity when adding the pre-doping agent.

### Examples 1 to 9

A pre-doping agent having a surface coated with AB, polyvinylidene fluoride (PVDF) as a binder and N-methyl-2-pyrrolidone (NMP) as a dispersion medium were premixed, and then the premixture was subjected to wet mixing using a planetary centrifugal mixer to obtain a slurry for interlayer (see Table 1). An aluminum foil having a thickness of 15 μm was then coated with the slurry for interlayer, followed by drying to form an interlayer. The thickness of the interlayer was then adjusted by roll pressing.

After premixing acetylene black (AB) (3.0 parts by mass), polyvinylidene fluoride (PVDF) (1.5 parts by mass), polyvinylpyrrolidone (PVP) (appropriate amount) as a dispersant and N-methyl-2-pyrrolidone (M4P) (appropriate amount), the premixture was subjected to wet mixing using a planetary centrifugal mixer to obtain a slurry. After mixing Li₁Ni_{0.8}Co_{0.1}Mn_{0.1}O₂ (NCM811) (95.5 parts by mass) and the slurry, the mixture was dispersed using a planetary mixer to obtain a paste for positive electrode mixture layer. Here, NCM811 has a median size of 12 μm. The interlayer was then coated with the paste for positive electrode mixture layer, followed by drying to form a positive electrode mixture layer. After roll pressing and drying in vacuum at 120° C., a positive electrode plate was obtained. The positive electrode plate was punched out to obtain a positive electrode having a size of 30 mm×40 mm.

### Comparative Example 1

In the same manner as in Example 1, except that the interlayer was not formed and a pre-doping agent having a surface coated with AB was added so that the solid content in the positive electrode mixture layer became 5% by mass, a positive electrode was obtained.

### Comparative Example 2

In the same manner as in Example 1, except that a pre-doping agent having a surface not coated with AB (see Table 1) was used in place of the pre-doping agent having a surface coated with AB, a positive electrode was obtained.

### [Fabrication of Negative Electrode]

A rolled copper foil having a thickness of 8 μm was punched out to obtain a negative electrode having a size of 34 mm×44 mm.

### [Separator]

As a separator, a polyethylene microporous film coated with alumina was used.

### [Electrolytic Solution]

LiFSI was dissolved in DME so that the concentration became 4 mol/L, and then LiNO₃ was dissolved so that the concentration became 1% by mass, thus obtaining an electrolytic solution.

### [Fabrication of Cell]

In a state where a separator is disposed as being sandwiched between a positive electrode and a negative electrode so that a surface coated with alumina of the separator is in contact with the positive electrode, an electrolytic solution was injected into the separator, followed by vacuum sealing using aluminum laminate to obtain an anode-free lithium metal secondary battery cell.

The initial performance of the lithium metal secondary battery cell was then evaluated.

### [Initial Capacity]

After a lithium metal secondary battery cell was left to stand at the measurement temperature (25° C.) for 1 hour, the battery cell was charged to 4.3 V with a constant current of 12.4 mA and then charged with a constant voltage of 4.3 V for 1 hour. After the lithium metal secondary battery cell was left to stand for 30 minutes, the battery cell was discharged to 2.65 V with a constant current of 12.4 mA. The above operation was repeated four times, and then the charging capacity at the time of 4th discharging was measured and defined as the initial capacity. The current value at which discharging is completed in 1 hour was defined as 1 C for the discharge capacity thus obtained.

### [Initial Resistance]

After the measurement of the initial capacity, the lithium metal secondary battery cell was left to stand at the measurement temperature (25° C.) for 1 hour, the battery cell was charged with a constant current of 0.2 C to adjust the state of charge (SOC) to 50%, and then the battery cell was left to stand for 10 minutes. The voltage at the time of pulse discharging at 0.5 C for 10 seconds was then measured. The current was plotted on the horizontal axis, and the voltage at the time of pulse discharging at 0.5 C for 10 seconds was plotted on the vertical axis. After the lithium metal secondary battery cell was left to stand for 10 minutes, auxiliary charging was carried out to return SOC to 50% and the battery cell was left to stand for additional 10 minutes. The above operation was carried out at each C-rate of 1.0 C, 1.5 C, 2.0 C, 2.5 C and 3.0 C, and plotting was performed in the same manner as above. The slope of the approximate line obtained from the plots by the least-squares method was determined and defined as the initial resistance of the lithium metal secondary battery cell.

The durability of the lithium metal secondary battery cell was then evaluated.

### [Post-Endurance Test Capacity]

As an endurance test of a lithium metal secondary battery cell, charging/discharging cycle of charging to 4.2 V with a constant current of 1 C in a constant temperature bath at 45° C. and discharging to 2.65 V with a constant current of 2 C was carried out for 50 cycles. After the lithium metal secondary battery cell was discharged in a constant temperature bath at 25° C. for 24 hours, the battery cell was charged to 4.3 V with a constant current of 0.33 C and then discharged with a constant voltage of 4.3 V for 1 hour. After the lithium metal secondary battery cell was left to stand for 5 minutes, the battery cell was discharged to 2.5 V with a constant current of 0.33 C, and then the charging capacity was measured and defined as the post-endurance test capacity.

### [Post-Endurance Test Resistance]

In the same manner as in the initial resistance, except that the lithium metal secondary battery cell was used after the measurement of the post-endurance test capacity, the post-endurance test resistance was determined.

### [Capacity Retention Rate]

A ratio of the post-endurance test capacity to the initial capacity was determined and defined as the capacity retention rate.

### [Resistance Increase Rate]

A ratio of the post-endurance test resistance to the initial resistance was determined and defined as the resistance increase rate.

### [Short Circuits]

Ten lithium metal secondary battery cells were subjected to the above endurance test and the number of cells in which short circuits were generated was determined.

The evaluation results of the lithium metal secondary battery cell are shown in Table 1.

TABLE 1

| | | | | | | | | | | | Comparative | |
|---|---|---|---|---|---|---|---|---|---|---|---|---|
| | | Example | | | | | | | | | Example | |
| | | 1 | 2 | 3 | 4 | 5 | 6 | 7 | 8 | 9 | 1 | 2 |
| Pre-doping | Material | LMO | LMO | LMO | LMO | LMO | LMO | LMO | LMO | LFO | LMO | LMO |
| agent | D₅₀ [μm] | 3.0 | 3.0 | 3.0 | 0.5 | 3.0 | 3.0 | 1.0 | 10.0 | 3.0 | 3.0 | 3.0 |
| | Initial irreversible | 88 | 90 | 80 | 88 | 85 | 85 | 90 | 88 | 75 | 60 | 60 |
| | capacity [%] | | | | | | | | | | | |
| | Initial charging capacity | 630 | 600 | 700 | 730 | 630 | 600 | 650 | 580 | 600 | 150 | 200 |
| | [mAh/g] | | | | | | | | | | | |
| Interlayer | Thickness[μm] | 10 | 10 | 10 | 1 | 20 | 10 | 12 | 10 | 10 | — | 10 |
| | Basis weight [mg/cm²] | 1.9 | 1.9 | 1.9 | 0.3 | 3.6 | 1.9 | 1.9 | 1.9 | 1.9 | — | 1.9 |
| | Pre-doping agent | 90.0 | 94.2 | 85.7 | 90.0 | 90.0 | 81.8 | 81.8 | 90.0 | 90.0 | — | 95.0 |
| | [% by mass] | | | | | | | | | | | |
| | AB [% by mass] | 5.0 | 1.0 | 9.5 | 5.0 | 5.0 | 9.1 | 9.1 | 5.0 | 5.0 | — | 0.0 |
| | Binder | 5.0 | 4.8 | 4.8 | 5.0 | 5.0 | 9.1 | 9.1 | 5.0 | 5.0 | — | 5.0 |
| | [% by mass] | | | | | | | | | | | |
| | Thickness [μm] | 60.6 | 60.6 | 60.6 | 61.6 | 60.6 | 60.6 | 60.6 | 60.6 | 60.6 | 65.8 | 62.5 |
| | Basis weight [mg/cm²] | 20.0 | 20.0 | 20.0 | 20.0 | 20.0 | 20.0 | 20.0 | 20.0 | 20.0 | 21.1 | 20.0 |

| | | | | | | | | | | | |
|---|---|---|---|---|---|---|---|---|---|---|---|
| Initial capacity [mAh] | 44.7 | 44.7 | 44.7 | 44.7 | 44.7 | 44.7 | 44.7 | 44.7 | 45.8 | 44.7 | 35.8 |
| Initial resistance [Ω] | 1.83 | 1.92 | 1.75 | 1.83 | 1.83 | 1.77 | 1.77 | 1.83 | 1.92 | 1.67 | 16.67 |
| Post-endurance test capacity [mAh] | 42.2 | 41.6 | 42.0 | 35.5 | 42.5 | 42.7 | 42.6 | 42.2 | 43.3 | 35.0 | 25.0 |
| Post-endurance test resistance [Ω] | 2.75 | 3.07 | 2.54 | 3.3 | 2.57 | 2.39 | 2.44 | 3.21 | 3.35 | 4.82 | 38.33 |
| Capacity retention rate [%] | 95 | 93 | 94 | 79 | 95 | 96 | 95 | 95 | 95 | 79 | 70 |
| Resistance increase rate [%] | 150 | 160 | 145 | 180 | 140 | 135 | 138 | 175 | 175 | 289 | 230 |
| Number of short circuits generated | 0 | 0 | 0 | 0 | 0 | 0 | 0 | 0 | 0 | 3 | 0 |

As is apparent from Table 1, the lithium metal secondary battery cells of Examples 1 to 9 exhibit high durability (capacity retention rate, resistance increase rate and short circuits). To the contrary, the lithium metal secondary battery cell of Comparative Example 1 exhibits low durability because the interlayer is not formed. In addition, the lithium metal secondary battery cell of Comparative Example 2 exhibits low durability, low initial capacity and high initial resistance because the interlayer contains no conductive aid.

What is claimed is:

1. A lithium secondary battery comprising a positive electrode, a negative electrode and an electrolytic solution,
the positive electrode including an interlayer and a positive electrode mixture layer sequentially stacked on a positive electrode current collector,
the interlayer including a pre-doping agent, a conductive aid and a binder.

2. The lithium secondary battery according to claim 1, wherein the negative electrode includes a lithium metal layer, a lithium alloy layer or a negative electrode mixture layer formed on a negative electrode current collector.

3. The lithium secondary battery according to claim 1, wherein the interlayer has a thickness of 1 μm or more and 20 μm or less.

4. The lithium secondary battery according to claim 1, wherein a ratio of the mass of the conductive aid with respect to the total mass of the pre-doping agent and the conductive aid in the interlayer is 0.01 or more and 0.10 or less.

5. The lithium secondary battery according to claim 1, wherein the pre-doping agent has a median size (D₅₀) of 10 μm or less.

6. The lithium secondary battery according to claim 1, wherein the pre-doping agent has an initial irreversible capacity of 50% or more and an initial charging capacity of 300 mAh/g or more.

7. The lithium secondary battery according to claim 1, wherein the pre-doping agent is a metal oxide having an inverse-fluorite structure represented by formula:
LiₐMe_{b}X_{(1-b)}O₄
wherein a is 5 or more and 6 or less, b is 0.8 or more and 1 or less, Me is one or more elements selected from the group consisting of Co, Mn and Fe, and X is a metal element other than Co, Mn, Fe and Ni, and
a surface of the metal oxide is coated with the conductive aid.
